(19) United States
(12) Patent Application Publication
(10) Pub. No.: US 2011/0131526 A1
(43) Pub. Date: Jun. 2, 2011

(54) OVERLAY USER INTERFACE FOR COMMAND CONFIRMATION

(75) Inventors: David Vronay, Beijing (CN); Yannis Paniaras, Beijing (CN); Li Qiao, Beijing (CN); Rebecca Jo Sundling, Seattle, WA (US)

(73) Assignee: Microsoft Corporation, Redmond, WA (US)

(21) Appl. No.: 12/628,234

(22) Filed: Dec. 1, 2009

(51) Int. Cl. G06F 3/048

(52) U.S. Cl. 715/808

(57) ABSTRACT

Confirmation is provided each time a command is initiated at an application program in the form of a temporary non-modal user interface (UI) overlay that is displayed in front of the UI windows generated by the application program that received the command. The overlay includes a bounding shape having text contained therein that identifies the command. The overlay might also include a graphical, textual, or numerical indication of a value being adjusted by a user in conjunction with execution of the command. The overlay might be displayed by fading the display of the overlay in over a period of time. The display of the overlay may then be removed by fading the display of the overlay out over a period of time. The overlay might also be displayed at the same on-screen position each time it is displayed.

### BACKGROUND

Computer user interfaces (“UIs”) are typically designed for use by only one user at a time. There are, however, many scenarios where multiple people use a single computer at a time. For instance, one person might operate a computer, such as a trainee, while another person watches the operator, such as a supervisor. In these cases, it can be confusing for the non-operating user to understand what the computer operator is doing.

Most computer UIs are also programmed using the assumption that received commands are intended by the user. For instance, most computer programs are programmed with the assumption that the user meant to print when a key press is received that corresponds to a print command. There are, however, cases where it is important for a computer user to be absolutely sure that the computer program is performing the action that the user intended.

One common mechanism for providing confirmation of a user command is through the use of a modal dialog box UI control. A modal dialog box UI control requires a user to manually dismiss the UI control, such as through the selection of a UI button. Because modal UI controls must be manually dismissed, this type of control may be disruptive to a user, especially where the user is performing interactive or continuous tasks. This type of UI control can also be visually distracting, especially when used in conjunction with application programs that provide functionality for displaying or editing images.

It is with respect to these and other considerations that the disclosure made herein is presented.

### SUMMARY

Concepts and technologies are described herein for providing confirmation of commands to a user of a computer system. Through an implementation of the concepts and technologies presented herein, confirmation can be provided for the initiation of commands at a computer in a visually distinct manner that is easy for a non-operator of the computer to see. Moreover, through an implementation of the concepts presented herein, confirmation of the initiation of commands at a computer can be provided in a manner that does not require user intervention to dismiss the confirmation and which, therefore, does not interfere with interactive or continuous user tasks.

According to one aspect presented herein, a visual command confirmation is provided in response to detecting the initiation of a command at a computer system. In various embodiments confirmation is provided each time a command is initiated at an application program in the form of a UI overlay that is displayed in front of the UI windows generated by the application program that received the command. The overlay is displayed temporarily and is non-modal. A user is therefore not required to manually dismiss the overlay. According to various embodiments, the overlay may be displayed for all detected commands or may be displayed only for important commands that require confirmation, such as a command that affects content displayed by the application program such as a document or an image.

According to various embodiments, the overlay includes a bounding shape having text contained therein that identifies the command. A user might be permitted to specify the bounding shape. According to other embodiments, the overlay might also include a graphical, textual, or numerical indication of a value being adjusted by a user in conjunction with execution of the command. For instance, if the detected command is for modifying the contrast of an image, the overlay might also display numerical information identifying the percentage of the contrast modification.

According to other embodiments, the overlay is displayed by fading the display of the overlay in over a period of time. The display of the overlay may then be removed by fading the display of the overlay out over a period of time. Fading of the overlay can be accomplished by modifying the opacity of the overlay. A user might be permitted to specify the duration of the fade-in and the fade-out of the overlay. A user might also be permitted to specify the colors utilized to display the overlay. Bounding shapes and colors for the overlay might be specified that visually distinguish the display of the overlay from the UI windows generated by the application program performing the detected command.

According to various embodiments, the overlay is displayed at the same on-screen position each time it is displayed. A user might also be permitted to specify the stationary position of the overlay. The overlay might also be displayed at a size suitable for reading from a distance by a non-operator user. In this regard, the size of the overlay might be scaled depending upon screen size and resolution in order to ensure that it is displayed at a sufficiently large size for over-the-shoulder viewing.

It should be appreciated that the above-described subject matter might also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an operating environment for the various embodiments disclosed herein;

FIGS. 2A-2C are user interface diagrams showing aspects of various user interfaces provided by a command confirmation overlay module disclosed herein in various embodiments;

FIGS. 3A-3C are line charts showing the timing of the display of a command confirmation overlay according to various embodiments presented herein;

FIG. 4 is a flow diagram showing aspects of one process presented herein for providing command confirmation; and

FIG. 5 is a computer architecture diagram showing an illustrative computer hardware and software architecture for a computing system capable of implementing aspects of the embodiments presented herein.

### DETAILED DESCRIPTION

The following detailed description is directed to technologies for command confirmation. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system, computer-readable storage medium, and computer-implemented methodology for providing command confirmation will be presented.

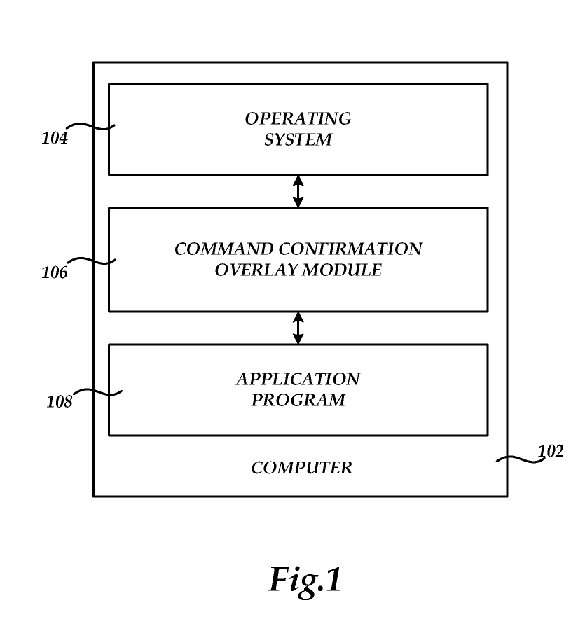

Referring now to FIG. 1, aspects of one operating environment for the various embodiments presented herein will be described. The operating environment shown in FIG. 1 includes a computer 102 configured to execute an operating system 104 and an application program 108. According to various embodiments, the computer 102 comprises a standard desktop or laptop personal computer system. It should be appreciated, however, that the computer 102 may comprise other types of computing systems, including a server computer, a handheld computer, an embedded computer system, a personal digital assistant, a mobile telephone, or another type of computing device known to those skilled in the art. It should also be appreciated that the computer 102 may be connected to one or more networks and operate in conjunction with other computing systems on the networks to provide the functionality described herein.

As known to those skilled in the art, the operating system 104 comprises a computer program for controlling the operation of the computer 102. The application program 108 is an executable program configured to execute on top of the operating system 104. The application program 108 may comprise any type of application program including, but not limited to, a word processing program, a spreadsheet program, an electronic mail program, a database program, a program for viewing and interacting with medical information, or another type of program. As will be discussed in greater detail below, the various technologies presented herein for command confirmation may be utilized with virtually any type of application program 108 that receives and performs commands based upon input provided by a user.

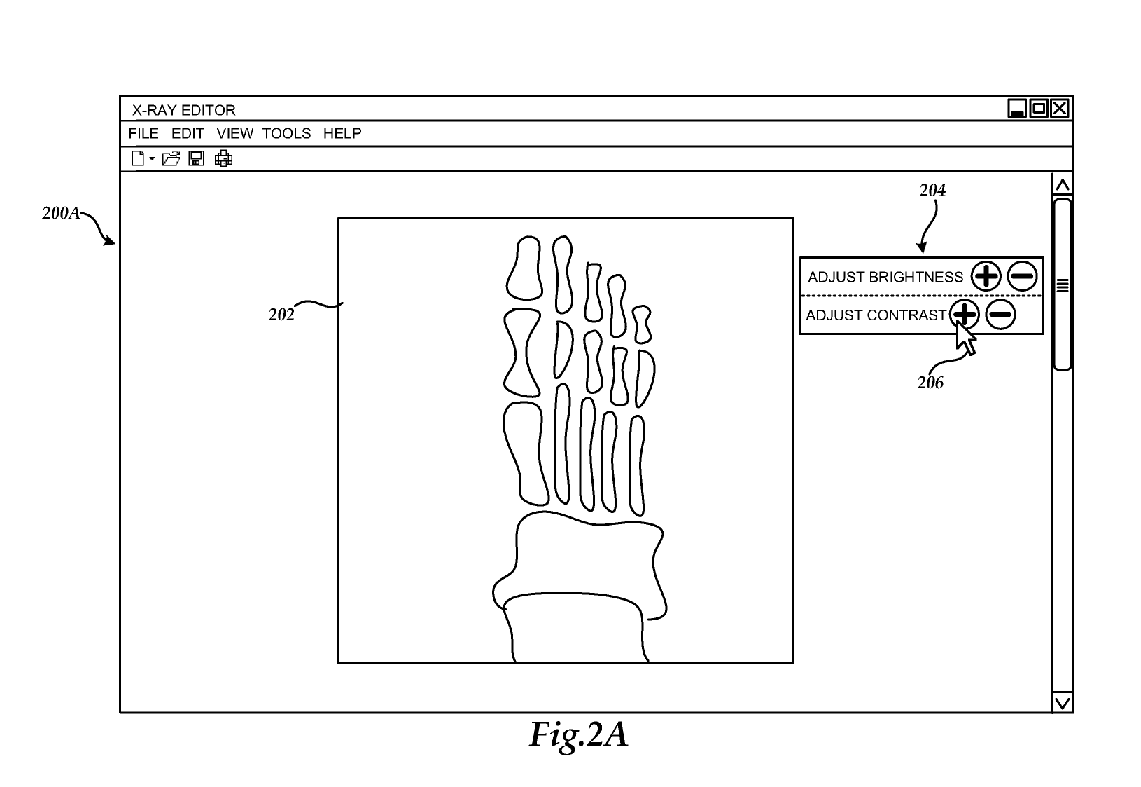

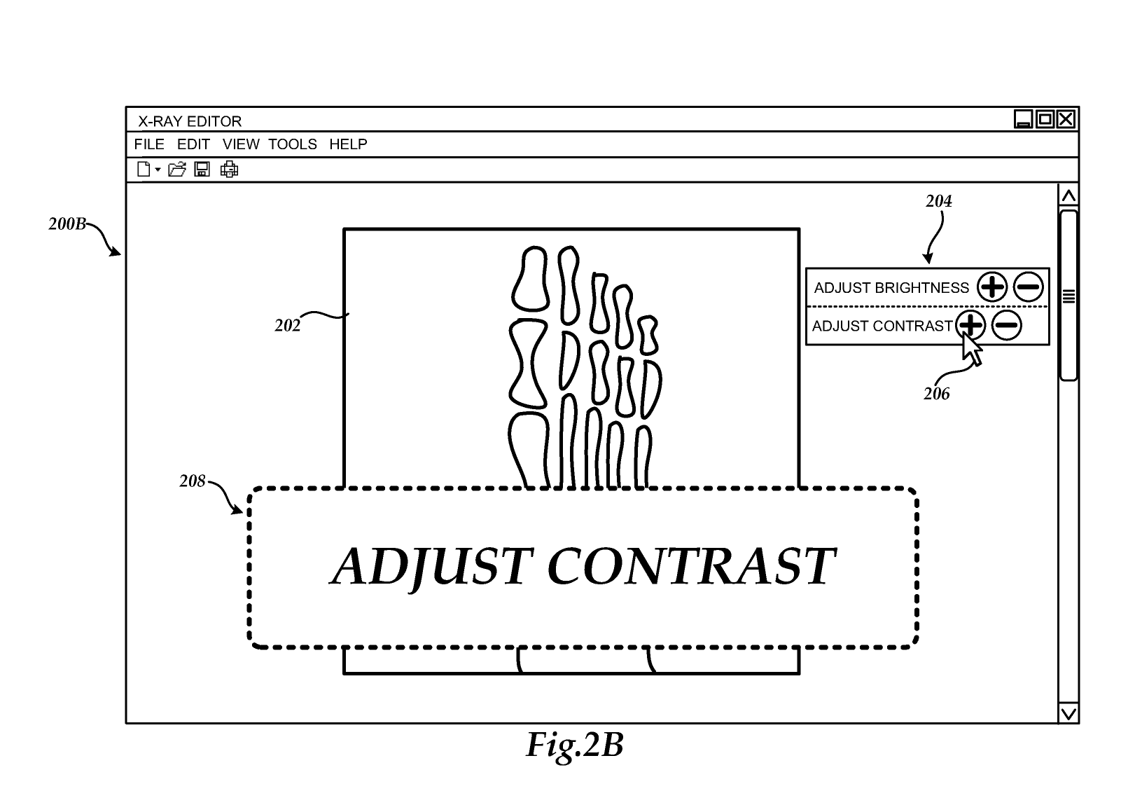

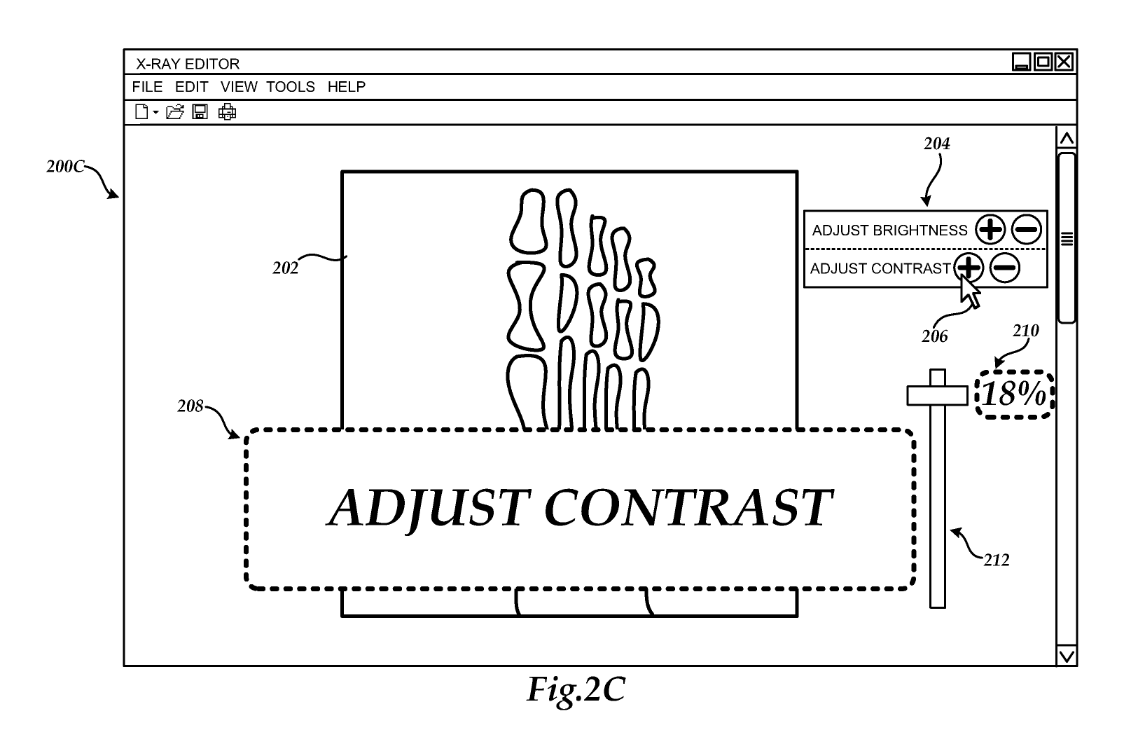

As will be described in greater detail below, a command confirmation overlay module 106 executes in conjunction with the application program 108 to provide the functionality disclosed herein for providing command confirmation. As illustrated in FIG. 2, the command confirmation overlay module 106 is a separate software module. It should be appreciated, however, that the functionality disclosed herein as being performed by the command confirmation overlay module 106 may be incorporated directly within the application program 108.

According to other implementations, the command confirmation overlay module 106 may operate in conjunction with the operating system 104 to provide confirmation of commands received at and performed by the operating system 104. In this regard, it should also be appreciated that the functionality disclosed herein as being performed by the command confirmation overlay module 106 might also be incorporated directly within the operating system 104. It should also be appreciated that the software architecture illustrated in FIG. 1 and described briefly above is merely illustrative and that other types of arrangements of software components for providing the functionality disclosed herein may be utilized. Additional details regarding the operation of the command confirmation overlay module 106 will be provided below with respect to FIGS. 2A-5.

Turning now to FIG. 2A, a user interface diagram showing aspects of a user interface provided by the application program 108 in one embodiment will be described. In particular, FIG. 2A shows a screen display 200A generated by the application program 108 according to one particular implementation presented herein. In this implementation, the application program 108 comprises an application program for viewing and modifying x-ray images. As discussed above, however, the application program 108 may comprise other types of application programs in other embodiments. In this regard, it should be appreciated that the screen diagrams illustrated in FIGS. 2A-2C are merely illustrative, and that the embodiments presented herein may be utilized with many types of user interfaces provided by many different types of application programs 108.

In the screen display 200A shown in FIG. 2A, an x-ray image 202 has been displayed by the application program 108. Additionally, a user interface 204 has been provided by the application program 108 for adjusting aspects of the image 202. In particular, the user interface 204 includes user interface controls for adjusting the brightness and the contrast of the image 202. Through the use of an appropriate user interface device, such as a mouse or keyboard, a user can select the various portions of the user interface 204 to modify the image 202 in the desired manner. As an example, in the screen display 200A in FIG. 2A, a mouse cursor 206 has been moved onto the user interface 204 utilizing a mouse or touch input device in order to adjust the contrast of the image 202.

It should be appreciated that the application program 108 may receive many different types of commands, such as the commands described above for adjusting the brightness and contrast of the image 202. Commands may be received through the use of a graphical user interface, such as the user interface 204, or through other mechanisms, such as dedicated keyboard commands. As utilized herein, therefore, the term “command” encompasses any request to perform functionality that is received from a user. In this regard, certain types of commands will cause content, such as the image 202, to be modified. For instance, the commands discussed above for adjusting the contrast or brightness of the image 202 will cause the image 202 to be modified. Other types of commands might be received that do not cause content to be modified by the application program 108. For instance, the user of the computer 102 may provide a command to the application program 108 to change a view of content, such as the image 202. Changing the view modifies the manner in which the content is presented to a user of the computer 102 but does not modify the content itself. In this regard, it should be appreciated that the term “command” as utilized herein encompasses both commands that cause content to be modified and commands that do not result in the modification of content.

As will be discussed in greater detail below, the command confirmation overlay module 106 operates in conjunction with the application program 108 to provide confirmation of commands received from a user. According to one implementation, a confirmation may be provided for all types of commands, including those commands that do not cause content to be modified. According to other embodiments, the command confirmation overlay module 106 is configured to display confirmations only for commands that cause content to be modified. Additional details regarding the operation of the command confirmation overlay module 106 and an illustrative user interface provided thereby are discussed below with reference to FIGS. 2B-2C.

Referring now to FIG. 2B, a user interface diagram showing aspects of a user interface provided by the application program 108 and the command confirmation overlay module 106 in one embodiment will be described. In particular, FIG. 2B shows a screen display 200B generated in part by the application program 108 and in part by the command confirmation overlay module 106. In the screen display 200B, the command confirmation overlay module 106 has caused a non-modal overlay 208 to be displayed in front of the user interface window generated by the application program 108 and illustrated in FIG. 2A. The overlay 208 provides a visual confirmation of the initiation of a command. For instance, in the example shown in FIG. 2B, the overlay 208 includes the text “Adjust Contrast”, thereby providing a visual confirmation of the initiation of the command for adjusting the contrast of the image 202 by way of a selection made using the mouse cursor 206.

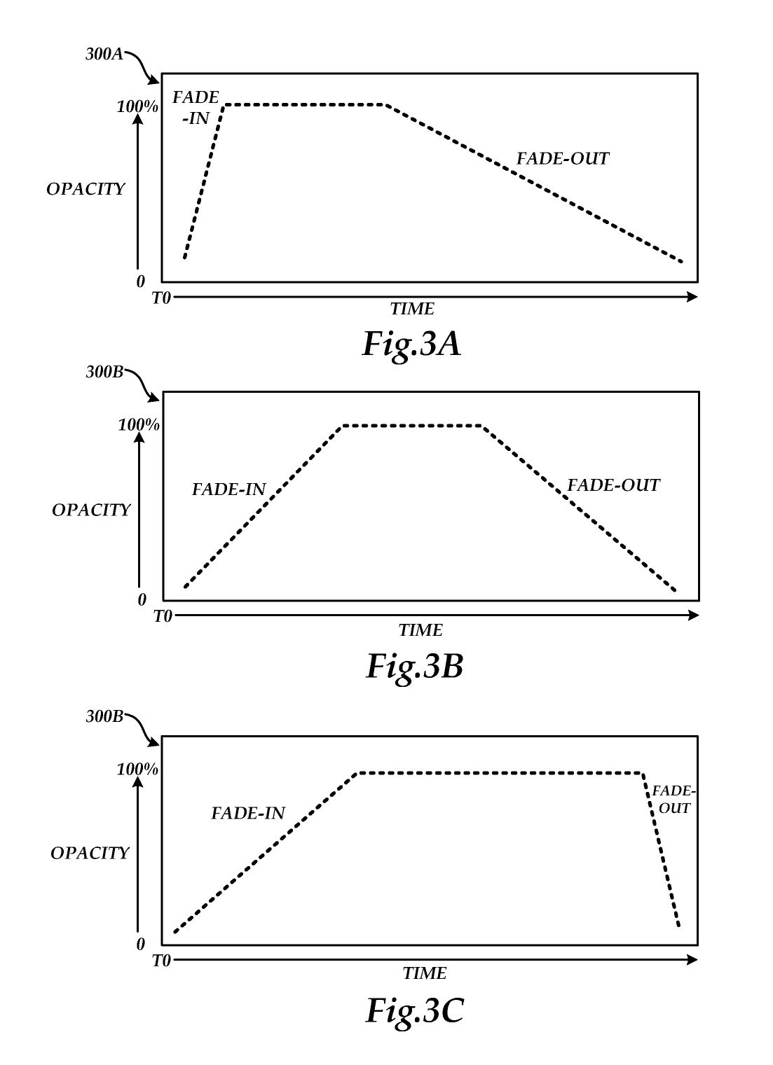

According to one implementation, the command confirmation overlay module 106 is configured to fade-in the display of the overlay 208. The overlay 208 may then be displayed for a period of time after which the command confirmation overlay module 106 is configured to fade-out the display of the overlay 208. The command confirmation overlay module 106 may fade the overlay 208 in and out by adjusting the opacity of the overlay 208. According to various implementations disclosed herein, a user of the computer 102 may be able to specify the durations of the periods of time during which the overlay 208 is faded-in and faded-out. Additional details in this regard will be provided below with respect to FIG. 3A-3C.

According to various embodiments, the overlay 208 is a bounding shape having text contained therein that identifies the detected command. For instance, the overlay 208 illustrated in FIG. 2B is a substantially rectangular bounding shape that includes the text “Adjust Contrast” for identifying the detected command for adjusting the contrast of the image 202. According to various embodiments, a user of the computer 102 may be permitted to specify the bounding shape of the overlay 208.

According to implementations, the overlay 208 is displayed using one or more colors that visually distinguish the overlay 208 from the user interface windows generated by the application program 108. In this regard, a user of the computer 102 may be permitted to select the color or colors used to display the overlay 208. The available colors for selection might be limited to those colors that visually distinguish the overlay 208 from windows generated by the application program 108 or the operating system 104. In a similar fashion, the available bounding shapes for the overlay 208 might be limited to those bounding shapes that visually distinguish the overlay 208 from user interface windows generated by the application program 108 and the operating system 104. According to one implementation, the overlay 208 is displayed at the same on-screen location each time it is displayed. A user of the computer 102 may be permitted to specify the stationary position of the overlay 208.

It should be appreciated that, according to other embodiments, other types of visual effects might be utilized to visually distinguish the overlay 208 from the user interface windows generated by the application program 108. For example, and without limitation, focus effects, depth of field effects, and simulated lighting effects might be utilized. Other types of visual effects might also be utilized in other implementations.

According to other aspects presented herein, the overlay 208 is presented in a size suitable for reading from a distance by a non-operator of the computer 102. In this regard, the size of the overlay 208 might be scaled depending on the size of the display screen and the resolution at which the overlay 208 is displayed. In this manner, it can be ensured that the overlay 208 is displayed at a sufficiently large size for over-the-shoulder viewing by a non-operator user.

Referring now to FIG. 2C, a screen display 200C will be described that includes additional user interface elements provided by the command confirmation overlay module 106 in one embodiment presented herein. In the example shown in FIG. 2C, the overlay 208 includes additional user interface elements that provide an indication of a value being adjusted by a user of the computer 102 in conjunction with the execution of a command. In particular, in the example shown in FIG. 2C, the mouse cursor 206 has been utilized to select aspects of a user interface 204 for adjusting the contrast of the image 202. In response to detecting such a command, the overlay 208 is displayed in conjunction with the indicator 210.

The indicator 210 provides an indication of the percentage of the adjustment made to the contrast of the image 202 through the received command. According to other implementations, a graphical indication of the value associated with the command may also be displayed. For instance, the user interface control 212 may be displayed providing a graphical representation of the value associated with the command. In the example shown in FIG. 2C, the user interface control 212 comprises a slider UI control that graphically illustrates the adjustment of the contrast of the image 202. It should be appreciated that other types of user interface controls and visual representations might similarly be displayed in order to provide a graphical, contextual, or numerical indication of a value being adjusted by a user in conjunction with the execution of a command. The indicator 210 and the user interface control 212 may also be faded in and out as discussed briefly above. It should also be appreciated that a user does not interact with the indicator 210 and the user interface control 212. Rather, the user manipulates another control, such as the user interface 204 and, in response thereto, the overlay 208 is displayed which might include the indicator 210 and the user interface control 212.

Referring now to FIGS. 3A-3C, several line charts showing the timing of the display of the overlay 208 according to various embodiments presented herein will be described. As discussed above, the overlay 208 is displayed temporarily and is non-modal. This means that a user is not required to manually dismiss the overlay 208. Rather, according to implementations, the overlay 208 is displayed by fading the display of the overlay in over a period of time. The display of the overlay may then be removed by fading the display of the overlay out over another period of time. Fading of the overlay in this manner can be accomplished by modifying the opacity of the overlay.

FIGS. 3A-3C show several line charts 300A-300B that illustrate several acceleration curves for adjusting the time periods for fading-in and fading-out of the overlay 208. For instance, in the example shown in FIG. 3A, the display of the overlay 208 is faded-in over a shorter period of time and faded-out over a longer period of time. In the example shown in FIG. 3B, this display of the overlay 208 is faded-in and faded-out over a substantially equivalent period of time. In the example shown in FIG. 3C, the display of the overlay 208 is faded-in over a relatively longer period of time and faded-out more quickly.

As discussed above, a user of the computer 102 might be permitted to specify the duration of the fade-in and the fade-out of the overlay 208. In this regard, several predefined acceleration curves, such as those shown in FIGS. 3A-3C may be presented to the user for assisting the user in specifying the manner in which the overlay 208 will be faded in and out. The acceleration curve may be modified by a user of the computer 102 utilizing an appropriate user interface in order to define the respective periods of time. A user might also be permitted to define a custom acceleration curve.

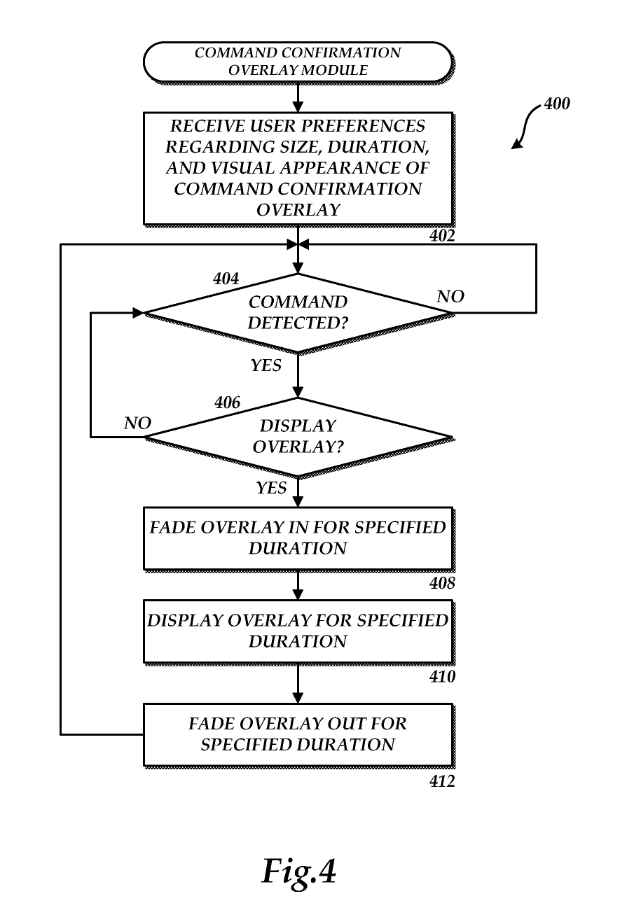

Referring now to FIG. 4 additional details will be provided regarding the embodiments presented herein for providing command confirmation. In particular, FIG. 4 is a flow diagram showing a routine 400 that illustrates aspects of the operation of the command confirmation overlay module 106 according to various embodiments presented herein.

It should be appreciated that the logical operations described herein with respect to FIG. 4 and the other figures are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 400 begins at operation 402, where preferences are received regarding the size, fade-in and fade-out duration, visual appearance, and location of the command confirmation overlay 208. Once the preferences have been received, the routine 400 proceeds to operation 404. At operation 404, the command confirmation overlay module 106 determines whether a command has been initiated at the application program 108. If the initiation of a command has not been detected, the routine 400 returns to operation 404.

If, at operation 404, the command confirmation overlay module 106 detects the initiation of a command, the routine 400 proceeds to operation 406. At operation 406, the command confirmation overlay module 106 determines whether the overlay 208 should be displayed. As discussed briefly above, in one implementation, the command confirmation overlay module 106 is configured to display an overlay 208 for each and every command initiated at the application program 108. In alternate embodiments, the command confirmation overlay module 106 is configured to display an overlay 208 only for those commands that modify content, such as the modification of an image. If the command confirmation overlay module 106 determines that the overlay 208 should not be displayed, the routine 400 proceeds to operation 404, described above. If, however, the command confirmation overlay module 106 determines that the overlay 208 should be displayed, the routine 400 proceeds to operation 408.

At operation 408, the command confirmation overlay 106 causes the overlay 208 to be faded-in over the specified duration of time. The indicator 210 and user interface control 212 might also be faded-in in a similar manner. Once the overlay 208 has been faded-in, the routine 400 proceeds to operation 410 where the overlay is displayed for a specified period of time. The routine 400 then proceeds to operation 412 where the command confirmation overlay module 106 fades the overlay 208 out over a specified period of time. The indicator 210 and the user interface control 212 may also be faded-out in a similar fashion. From operation 412, the routine 400 proceeds to operation 404, discussed above.

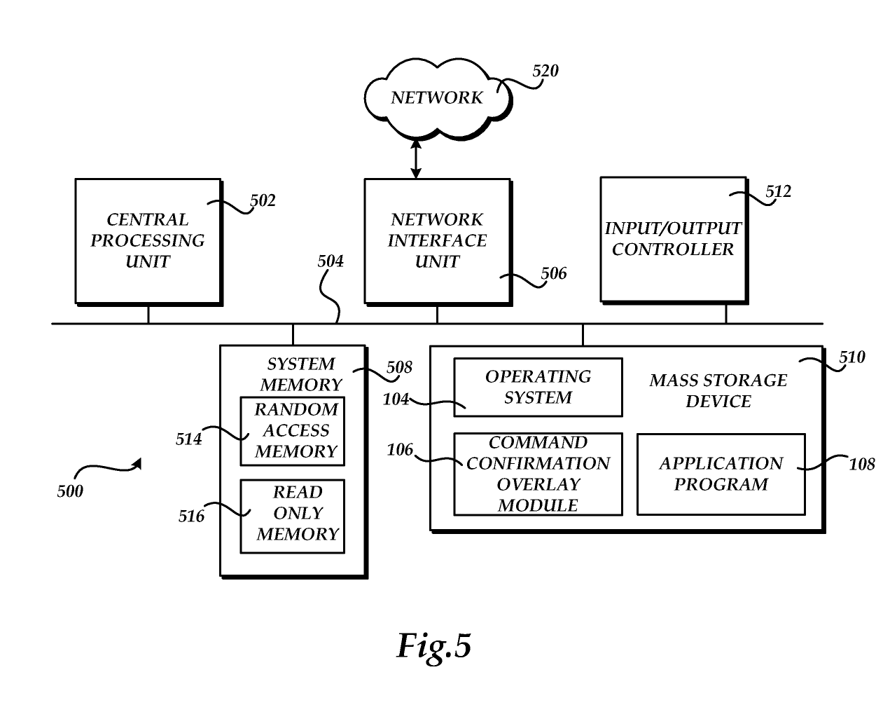

FIG. 5 shows an illustrative computer architecture for a computer 500 capable of executing the software components described herein for providing command confirmation in the manner presented above. The computer architecture shown in FIG. 5 illustrates a conventional desktop, laptop, or server computer and may be utilized to execute any aspects of the software components presented herein.

The computer architecture shown in FIG. 5 includes a central processing unit 502 (“CPU”), a system memory 508, including a random access memory 514 (“RAM”) and a read-only memory (“ROM”) 516, and a system bus 504 that couples the memory to the CPU 502. A basic input/output system containing the basic routines that help to transfer information between elements within the computer 500, such as during startup, is stored in the ROM 516. The computer 500 further includes a mass storage device 510 for storing an operating system 104, application programs, and other program modules, which are described in greater detail herein.

The mass storage device 510 is connected to the CPU 502 through a mass storage controller (not shown) connected to the bus 504. The mass storage device 510 and its associated computer-readable media provide non-volatile storage for the computer 500. Although the description of computer-readable media contained herein refers to a mass storage device, such as a hard disk or CD-ROM drive, it should be appreciated by those skilled in the art that computer-readable media can be any available computer storage media that can be accessed by the computer 500.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 500.

According to various embodiments, the computer 500 may operate in a networked environment using logical connections to remote computers through a network such as the network 520. The computer 500 may connect to the network 520 through a network interface unit 506 connected to the bus 504. It should be appreciated that the network interface unit 506 may also be utilized to connect to other types of networks and remote computer systems. The computer 500 may also include an input/output controller 512 for receiving and processing input from a number of other devices, including a keyboard, mouse, or electronic stylus (not shown in FIG. 5). Similarly, an input/output controller may provide output to a display screen, a printer, or other type of output device (also not shown in FIG. 5).

As mentioned briefly above, a number of program modules and data files may be stored in the mass storage device 510 and RAM 514 of the computer 500, including an operating system 104 suitable for controlling the operation of a networked desktop, laptop, or server computer. The mass storage device 510 and RAM 514 may also store one or more program modules. In particular, the mass storage device 510 and the RAM 514 may store the command confirmation overlay module 106 and the application program 108, each of which was described in detail above with respect to FIGS. 1-4. The mass storage device 510 and the RAM 514 may also store other types of program modules and data.

It should be appreciated that the software components described herein may, when loaded into the CPU 502 and executed, transform the CPU 502 and the overall computer 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein may also transform the physical structure of the computer-readable media presented herein. The specific transformation of physical structure may depend on various factors, in different implementations of this description. Examples of such factors may include, but are not limited to: the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software may also transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 500 in order to store and execute the software components presented herein. It also should be appreciated that the computer 500 may comprise other types of computing devices, including hand-held computers, embedded computer systems, personal digital assistants, and other types of computing devices known to those skilled in the art. It is also contemplated that the computer 500 may not include all of the components shown in FIG. 5, may include other components that are not explicitly shown in FIG. 5, or may utilize an architecture completely different than that shown in FIG. 5.

Based on the foregoing, it should be appreciated that technologies for providing command confirmation have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing command confirmation, the computer-implemented method comprising performing computer-implemented operations for:
detecting the initiation of a command at an application program executing on a computer; and
each time a command is initiated at the application program, temporarily displaying a non-modal overlay in front of one or more user interface windows generated by the application program, the overlay providing a visual confirmation of the initiation of the command.

2. The computer-implemented method of claim 1, wherein the command comprises a command affecting content displayed by the application program.

3. The computer-implemented method of claim 1, wherein the overlay comprises a bounding shaping having text contained therein that identifies the command.

4. The computer-implemented method of claim 3, wherein the overlay further comprises an indication of a value being adjusted by a user in conjunction with execution of the command.

5. The computer-implemented method of claim 1, wherein temporarily displaying the overlay comprises fading in a display of the overlay for a first period of time and fading out the display of the overlay out for a second period of time.

6. The computer-implemented method of claim 5, wherein the first period of time and the second period of time are user-definable.

7. The computer-implemented method of claim 1, wherein the overlay is displayed at the same location each time it is displayed.

8. The computer-implemented method of claim 7, wherein the location is user-definable.

9. The computer-implemented method of claim 1, wherein the overlay is displayed using one or more colors that visually distinguish the overlay from the user interface windows generated by the application program.

10. The computer-implemented method of claim 9, wherein the colors are user-definable.

11. The computer-implemented method of claim 1, wherein the overlay is displaying using a bounding shape that visually distinguishes the overlay from the user interface windows generated by the application program.

12. The computer-implemented method of claim 11, wherein the bounding shape is user-definable.

13. A computer-readable storage medium having computer-readable instructions stored thereupon which, when executed by a computer, cause the computer to:
receive a request to perform a command at an application program; and
in response to receiving the request, to display a non-modal overlay in front of one or more application windows generated by the application program, the non-modal overlay comprising a bounding shape having text contained therein for confirming the performance of the command.

14. The computer-readable storage medium of claim 13, wherein the overlay further comprises an indication of a value being adjusted by a user in conjunction with the performance of the command.

15. The computer-readable storage medium of claim 13, wherein temporarily displaying the overlay comprises fading in a display of the overlay for a user-definable first period of time and fading out the display of the overlay out for a user-definable second period of time.

16. The computer-readable storage medium of claim 13, wherein the overlay is displayed at the same user-definable location each time it is displayed.

17. The computer-readable storage medium of claim 13, wherein the overlay is displayed using one or more user-definable colors that visually distinguish the overlay from the user interface windows generated by the application program.

18. The computer-readable storage medium of claim 13, wherein the bounding shape comprises a user-definable shape that visually distinguishes the overlay from the user interface windows generated by the application program.

19. The computer-readable storage medium of claim 13, wherein the command comprises a command affecting content displayed by the application program.

20. A computer-readable storage medium having computer-readable instructions stored thereupon which, when executed by a computer, cause the computer to:
detect a request to perform a command at an application program; and
in response to detecting the request, to fade-in a display of a non-modal overlay in front of one or more user interface windows displayed by the application program and to fade-out the display of the overlay after a user-defined period of time, the overlay comprising a bounding shaping having text contained therein for confirming the performance of the command and an indication of a value being adjusted by a user in conjunction with the performance of the command and being displayed at a stationary position each time the overlay is displayed.
